(19) United States
(12) Patent Application Publication
(10) Pub. No.: US 2024/0151874 A1
(43) Pub. Date: May 9, 2024

(54) WATER VAPOR OBSERVATION METHOD

(71) Applicant: NEC Corporation, Minato-ku, Tokyo (JP)

(72) Inventor: Michihiko YUSA, Tokyo (JP)

(73) Assignee: NEC Corporation, Minato-ku, Tokyo (JP)

(21) Appl. No.: 18/281,431

(22) PCT Filed: Feb. 4, 2022
(86) PCT No.: PCT/JP2022/004459

§ 371 Date: Sep. 11, 2023

(30) Foreign Application Priority Data
Mar. 15, 2021 (JP) 2021-041771

(51) Int. Cl. G01W 1/18; G01S 19/14

(52) U.S. Cl. CPC G01W 1/18; G01S 19/14

(57) ABSTRACT

A water vapor observation apparatus of the present invention includes: an acquiring unit that acquires a water vapor value at each predetermined point measured based on a received signal from a satellite; an extracting unit that extracts a feature value for each predetermined point from a captured image captured from the sky; and a correcting unit that corrects the water vapor value based on the feature value for each predetermined point.

### TECHNICAL FIELD

The present invention relates to a water vapor observation method, a water vapor observation apparatus, and a program.

### BACKGROUND ART

Estimating a water vapor content in the atmosphere is performed as a method for weather observation. For example, there is a known technique of, when receiving a GPS signal transmitted from a GPS (Global Positioning System) satellite on the ground, measuring the delay time of the GPS signal due to water vapor in the atmosphere to estimate a water vapor content in the atmosphere at the reception point as described in Patent Literature 1. This enables prediction of rainfall at each point, especially, prediction of torrential rain caused by sudden outbreak of a cumulonimbus cloud.

### CITATION LIST

### Patent Literature

Patent Literature 1: Japanese Unexamined Patent Application Publication No. JP-A 2012-198645 SUMMARY OF INVENTION

### Technical Problem

However, places to install receiving apparatuses that receive GPS signals are limited and, in some places, the distance therebetween is 30 km. Although a water vapor content at a point between the receiving apparatuses needs to be estimated from values at the points where the receiving apparatuses are installed, it is difficult to accurately estimate a water vapor content at a point where it is not actually measured. Even at the place where the receiving apparatus is installed, further improvement in accuracy cannot be achieved when a water vapor content is estimated solely from a GPS signal. As a result, there arises a problem that it is difficult to more accurately observe a water vapor content at every point.

Accordingly, an object of the present invention is to provide a water vapor observation method that can solve the abovementioned problem that it is difficult to more accurately observe a water vapor content at every point.

### Solution to Problem

A water vapor observation method as an aspect of the present invention includes: acquiring a water vapor value at each predetermined point measured based on a received signal from a satellite; extracting a feature value for each predetermined point from a captured image captured from sky; and correcting the water vapor value based on the feature value for each predetermined point.

Further, a water vapor observation apparatus as an aspect of the present invention includes: an acquiring unit that acquires a water vapor value at each predetermined point measured based on a received signal from a satellite; an extracting unit that extracts a feature value for each predetermined point from a captured image captured from sky; and a correcting unit that corrects the water vapor value based on the feature value for each predetermined point.

Further, a program as an aspect of the present invention includes instructions for causing an information processing apparatus to execute processes to: acquire a water vapor value at each predetermined point measured based on a received signal from a satellite; extract a feature value for each predetermined point from a captured image captured from sky; and correct the water vapor value based on the feature value for each predetermined point.

### Advantageous Effects of Invention

With the configurations as described above, the present invention enables more accurate observation of a water vapor content at every point.

### BRIEF DESCRIPTION OF DRAWINGS

FIG. 1 is a view of an overall configuration of a water vapor observation system in a first example embodiment of the present invention.

FIG. 2 is a block diagram showing a configuration of a water vapor observation apparatus disclosed in FIG. 1.

FIG. 3 is a view showing an example of a satellite image processed by the water vapor observation apparatus disclosed in FIG. 1.

FIG. 4 is a flowchart showing operation of the water vapor observation apparatus disclosed in FIG. 1.

FIG. 5 is a block diagram showing a hardware configuration of a water vapor observation apparatus in a second example embodiment of the present invention.

FIG. 6 is a block diagram showing a configuration of the water vapor observation apparatus in the second example embodiment of the present invention.

FIG. 7 is a flowchart showing operation of the water vapor observation apparatus in the second example embodiment of the present invention.

### DESCRIPTION OF EMBODIMENTS

### First Example Embodiment

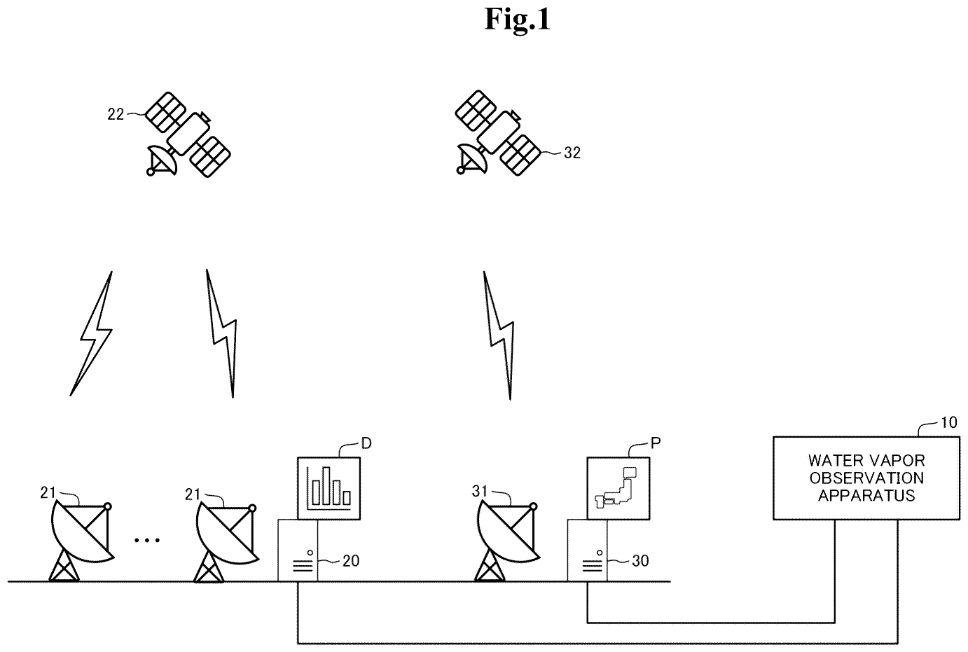

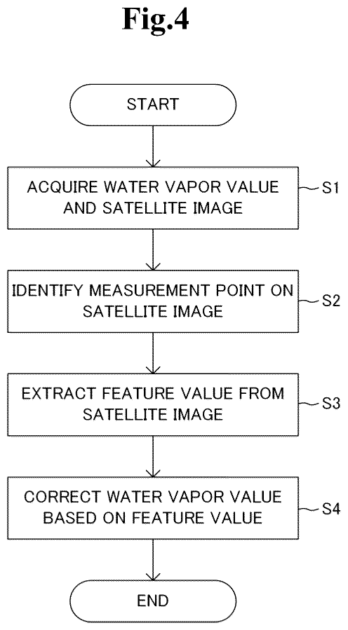

A first example embodiment of the present invention will be described with reference to FIGS. 1 to 4. FIGS. 1 to 3 are views for describing a configuration of a water vapor observation system, and FIG. 4 is a view for describing processing operation of the water vapor observation apparatus.

### Configuration

The water vapor observation system in the present invention is a system for performing weather observation for weather prediction, and is particularly for observing a water vapor value indicating a water vapor content at each point in order to predict rainfall and torrential rain.

As shown in FIG. 1, the water vapor observation system includes a water vapor observation apparatus 10, and a weather information providing apparatus 20 and a satellite image providing apparatus 30 that are connected to the water vapor observation apparatus 10 via a network. The configurations of the respective apparatuses will be described in detail below.

The weather information providing apparatus 20 is connected to a GPS (Global Positioning System) signal receiving device 21 installed on the ground. The GPS signal receiving device 21 receives a GPS signal, which is a radio signal transmitted from a GPS satellite 22 in the sky above the Earth, and provides the weather information providing apparatus 20 with the GPS signal. The GPS signal receiving devices 21 are located at a plurality of points on the ground, and some may be as far as 30 km away from the other GPS signal receiving devices, for example. However, the GPS signal receiving device 21 is not necessarily fixed and installed on the ground, and may be configured as a mobile object such as being mounted on a vehicle.

The weather information providing apparatus 20 is an information processing apparatus including an arithmetic logic unit and a memory unit, and has a function to analyze the acquired GPS signal and thereby measure a water vapor value D representing a water vapor content in the sky at a point corresponding to the installation location of the GPS signal receiving device 21. Specifically, the weather information providing apparatus 20 measures the water vapor value D in the atmosphere by measuring the delay time of the received GPS signal due to water vapor in the atmosphere. Moreover, the weather information providing apparatus 20 analyzes the GPS signals acquired from the plurality of GPS signal receiving devices 21, respectively, and measures the water vapor values D at the respective points. At this time, for a point where the GPS signal receiving device 21 is not installed, the weather information providing apparatus 20 measures a value calculated from the water vapor values D at a nearby point where the GPS signal receiving device 21 is installed as the water vapor value D at the point where the GPS signal receiving device 21 is not installed. Thus, the weather information providing apparatus 20 measures the water vapor values D at a plurality of measurement points including a point where the GPS signal receiving device 21 is installed and a point where the GPS signal receiving device 21 is not installed. Then, the weather information providing apparatus 20 has a function to associate location information indicating the location of each measurement point with the water vapor value D at the measurement point and provide them to the water vapor observation apparatus 10.

The function to measure the water vapor value of the weather information providing apparatus 20 described above can be realized by execution of a program for realizing the function by the arithmetic logic unit of the weather information providing apparatus 20. However, the measurement of the water vapor value by the weather information providing apparatus 20 may be performed by any apparatus, and may be performed by another method.

The satellite image providing apparatus 30 is connected to a satellite image receiving device 31 installed on the ground. The satellite image receiving device 31 receives a satellite image P (captured image) relating to weather captured and transmitted by an imaging device mounted on a weather satellite 32 in the sky above the Earth, and provides the satellite image providing apparatus 30 with the satellite image P. The satellite image providing apparatus 30 has a function to provide the water vapor observation apparatus 10 with the acquired satellite image P. The satellite image P is an image of an area including each measurement point where the abovementioned water vapor value is measured and, for example, in the case of measurement of a water vapor content at each measurement point in Japan, the satellite image P is an image of an area showing the mainland of Japan and the sea, islands, continents and so forth around Japan. Moreover, there are a plurality of types of satellite images P, and the satellite image providing apparatus 30 provides the water vapor observation apparatus 10 with the satellite images P together with information indicating the types thereof.

The types of the satellite images P include, for example, a visible image, an infrared image, a water vapor image, a cloud top enhanced image, a color composite image, and a true color reproduction image. A “visible image” is an image obtained by observing sunlight reflected by clouds and the ground surface, and has a characteristic of showing a cloud having developed with rain in white because it is thick and strongly reflects sunlight. An “infrared image” is an image obtained by observing infrared rays radiated from clouds, the ground surface and the atmosphere, and has a characteristic of depicting a cloud with lower temperature in whiter because the intensity of the radiated infrared rays has a property of changing with the temperature of the clouds. For example, clouds with low temperatures include thick clouds such as cumulonimbus clouds bringing summer evening showers and torrential rains, and also include thin clouds such as cirrus clouds appearing thinly in the sky far above on a sunny day.

A “water vapor image” is a kind of infrared image, and is an image obtained by observing infrared radiation (6.2 μM band) from water vapor in the atmosphere and clouds. Because infrared ray in this wavelength band has a property of being well absorbed by water vapor in the atmosphere and, at the same time, being radiated from that water vapor, a water vapor image enables observation of radiation from very little water vapor in the upper and middle troposphere even in the absence of clouds. For example, processing is performed so that a place where water vapor in the upper and middle troposphere is much is shown in white and a place where water vapor is little is shown in black, and a water vapor image thereby shows the moisture content of the upper atmosphere. A “cloud top enhanced image” is an image in which a visible image shows a daytime area and an infrared image shows a nighttime area and, on these images, an area with high cloud-top cloud is colored. The temperatures of clouds vary with the altitudes thereof, and the intensities of infrared rays radiated from the clouds vary with the temperatures. Consequently, the temperature of the cloud can be known from the intensity of the observed infrared ray and the altitude of the cloud (cloud top altitude) is estimated, and a place with high cloud top altitude is enhanced and shown in a specific color (red).

A “color composite image” includes an image obtained by combining three bands (blue, green, and red) of a visible image, and color images of an infrared image and a water vapor image in which the land is colored in green and the sea is colored in blue. A “true-color reproduction image” is an image obtained by combining a plurality of band images of different wavelengths and reproducing in colors as seen by human eyes.

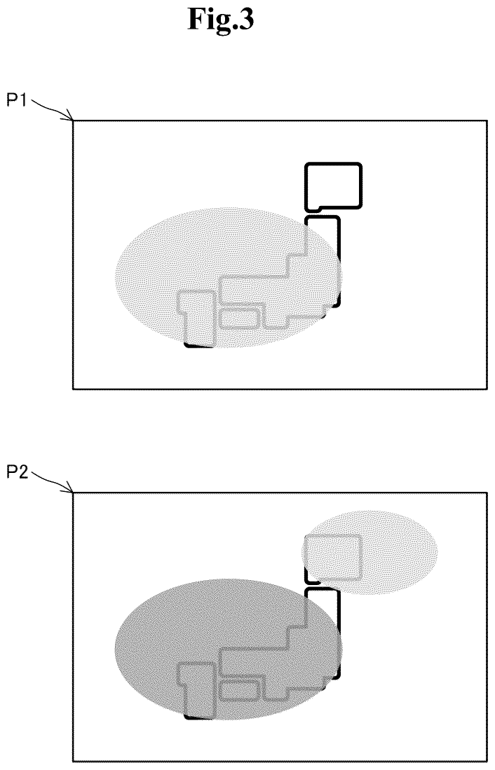

Here, an example of the satellite image P described above is shown by symbols P1 and P2 in FIG. 3. As shown in shaded gray parts in symbols P1 and P2 in FIG. 3, a weather condition that can be observed in each type of image, such as the presence or absence of cloud, the thickness of cloud, the height of cloud, the temperature of cloud, and a water vapor content, is enhanced. Although FIG. 3 shows in grayscale and thus illustrates a weather condition with a gray part, in actuality, a weather condition is displayed in a color set for each type of satellite image P. The satellite image P is not necessarily limited to the abovementioned types.

Further, the satellite image providing apparatus 30 also acquires satellite location information identifying the location in the sky of the weather satellite 32 when acquiring the satellite image P from the weather satellite 32. Furthermore, when acquiring the satellite images P from a plurality of weather satellites 32, the satellite image providing apparatus 30 also acquires satellite identification information identifying the weather satellites 32. Then, the satellite image providing apparatus 30 provides the water vapor measurement apparatus 10 with the satellite image P together with the type of the image and the satellite location information and satellite identification information of the weather satellite 32 having captured the satellite image. The function to acquire and provide the satellite image P of the satellite image providing apparatus 30 described above can be realized by execution of a program for realizing the function by an arithmetic logic unit of the satellite image providing apparatus 30. However, the acquisition and provision of a satellite image by the satellite image providing apparatus 30 may be performed by any apparatus and may be performed by another method.

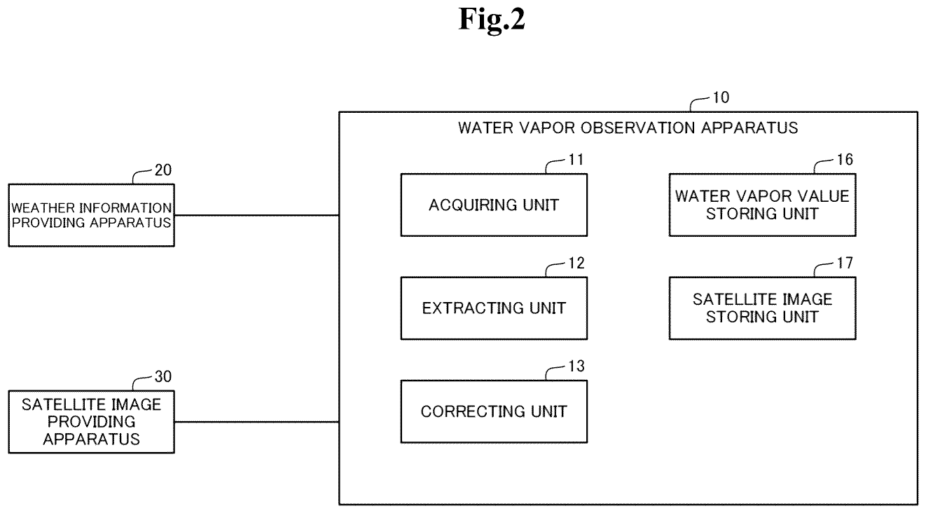

The water vapor observation apparatus 10 is configured by one or a plurality of information processing apparatuses each including an arithmetic logic unit and a memory unit. Then, the water vapor observation apparatus 10 includes an acquiring unit 11, an extracting unit 12, and a correcting unit 13 as shown in FIG. 2. The respective functions of the acquiring unit 11, the extracting unit 12 and the correcting unit 13 can be realized by execution of programs for realizing the respective functions stored in the memory unit by the arithmetic logic unit. The water vapor observation apparatus 10 also includes a water vapor value storing unit 16 and a satellite image storing unit 17. The water vapor value storing unit 16 and the satellite image storing unit 17 are configured by the memory unit. Below, the respective components will be described in detail.

The acquiring unit 11 acquires the water vapor value D at each measurement point provided from the weather information providing apparatus 20 described above, and stores the water vapor value D into the water vapor value storing unit. At this time, the acquiring unit 11 stores location information identifying each measurement point and the water vapor value D at the measurement point in association with each other. The acquiring unit 11 also acquires the satellite image P provided from the satellite image providing apparatus 30 described above, and stores the satellite image P into the satellite image storing unit 17. At this time, the acquiring unit 11 associates and stores the satellite image P, the type of the image, and the satellite location information and satellite identification information of the weather satellite 32 having captured the satellite image.

The extracting unit 12 retrieves the satellite image P from the satellite image storing unit 17, and first executes a process to identify, on the satellite image P, the location of each measurement point where the water vapor value D has been measured. For example, based on the satellite location information associated with the satellite image P and GPS reception location information representing the location of the GPS signal receiving device 21 described above, the extracting unit 12 calculates the angle between the weather satellite 32 having captured the satellite image P and the GPS signal receiving device 21. It is assumed that the GPS reception location information of the GPS signal receiving device 21 is stored in the water vapor observation apparatus 10 in advance. The extracting unit 12 then identifies the location of each measurement point on the satellite image P based on the satellite location information, GPS location information, and also the calculated angle between the weather satellite 32 and the GPS signal receiving device 21. In particular, the extracting unit 12 identifies, on the satellite image P, not only a measurement point that is the location of the GPS signal receiving device 21, but also a measurement point where the GPS signal receiving device 21 is not installed but the water vapor value D has been measured as described above.

Then, the extracting unit 12 extracts an image feature value at each measurement point on the satellite image P from the satellite image P. Specifically, based on the type of the satellite image P, the extracting unit 12 extracts an image feature value representing the condition of cloud and water vapor that can be extracted based on the characteristic of the image. For example, in a case where the satellite image P is a “visible image”, which has a characteristic that a part with thick cloud tends to appear white, the extracting unit 12 extracts an image feature value representing the degree of whiteness at each measurement point. In a case where the satellite image P is an “infrared image”, which has a characteristic that cloud with a lower temperature is expressed whiter, the extracting unit 12 extracts an image feature value representing the degree of whiteness at each measurement point. In a case where the satellite image P is a “water vapor image”, which has a characteristic that a place with much water vapor is expressed in white, the extracting unit 12 extracts an image feature value representing the degree of whiteness at each measurement point. In a case where the satellite image P is a “cloud top enhanced image”, which has a characteristic that an area with cloud of high cloud top is colored in a specific color, the extracting unit 12 extracts an image feature value representing the degree of the specific color at each measurement point. However, the extracting unit 12 is not necessarily limited to extracting the abovementioned image feature values, and may extract another image feature value. For example, the extracting unit 12 is not limited to extracting a feature value on an image representing the condition of cloud and water vapor, and may extract a feature value of image information representing a condition relating to weather such as temperature and wind direction.

The correcting unit 13 corrects the water vapor value D at each measurement point stored in the water vapor value storing unit 16 based on the image feature value at the measurement point. Since the image feature value extracted as described above is a value representing the condition of cloud and water vapor based on the type of the satellite image P, the correcting unit 13 corrects the water vapor value D measured based on the GPS signal, based on the condition of cloud and water vapor at each measurement point. As an example, in a case where the satellite image P is a “visible image”, the thickness of cloud at the measurement point can be known from the image feature value and, when the cloud is thick, the water vapor value D measured from the GPS signal may be higher than the actual value, so that the value of the water vapor value D is corrected to be lower. Also, as an example, in a case where the satellite image P is a “cloud top enhanced image”, the height of cloud at the measurement point can be known from the image feature value and, when the cloud is high, the cloud is expected to be thick and the water vapor value D measured from the GPS signal may be higher than the actual value, so that the value of the water vapor value D is corrected to be lower. Also, as an example, in a case where the satellite image P is a “water vapor image”, a water vapor content at the measurement point can be known from the image feature value, so that the correcting unit 13 compares the water vapor value D measured from the GPS signal with the water vapor content based on the image feature value, and corrects the water vapor value D by increasing or decreasing the value depending on the comparison result.

Further, in a case where there are a plurality of satellite images P obtained by capturing the same measurement point, the correcting unit 13 corrects the water vapor value D at the measurement point based on image feature values at the same measurement point obtained from the captured images P, respectively. For example, in a case where there are satellite images P of different types from each other, the correcting unit 13 provides the image feature value for each type with a preset weight based on the type, and corrects the water vapor value D based on the image feature value provided with the weight. That is to say, in a case where there are a plurality of kinds of satellite images P, the correcting unit 13 changes an influence of the image feature value of the satellite image P depending on type, and corrects the water vapor value D. As an example, in a case where there are a “visible image” and a “water vapor image” as the types of the satellite images P, and a weight for the “visible image” is set to “0.3” and a weight for the “water vapor image” is set to “0.7”, the correcting unit 13 corrects the water vapor value D so that an influence of the image feature value extracted from the “water vapor image” is reflected more than an influence of the image feature value extracted from the “visible image”.

Further, in a case where there are satellite images P captured by the weather satellites 32 different from each other, the correcting unit 13 provides each image feature value with a preset weight for each weather satellite 32, and corrects the water vapor value D based on the image feature value provided with the weight. That is to say, in a case where there are satellite images P captured by a plurality of weather satellites 32, the degree of reliability and the degree of influence of the satellite images P may vary with the weather satellites 32 or imaging devices mounted thereon, so that the correcting unit 13 changes an influence of the image feature value of the satellite image P depending on the weather satellite 32, and corrects the water vapor value D. As an example, in a case where there are the satellite image P of a “weather satellite A” and the satellite image P of a “weather satellite B”, and a weight for the “weather satellite A” is set to “0.3” and a weight for the “weather satellite B” is set to “0.7”, the correcting unit 13 corrects the water vapor value D so that an influence of the image feature value extracted from the satellite image P captured by the “weather satellite B” is reflected more than an influence of the image feature value of the satellite image P captured by the “weather satellite A”.

The correcting unit 13 stores the water vapor value D corrected as described above into the water vapor value storing unit 16. Then, the correcting unit 13 outputs the water vapor value D stored in the water vapor value storing unit 16 together with the location information representing the measurement point as necessary, for example, at the time of using for weather prediction.

### Operation

Next, the operation of the above water vapor observation apparatus 10 will be described mainly with reference to a flowchart of FIG. 4. First, it is assumed that the weather information providing apparatus 20 previously acquires a GPS signal transmitted from the GPS satellite 22 in the sky above the Earth, measures the water vapor value D from a delay time of the signal and stores the value as the water vapor value D at a measurement point that is the installation location of the GPS signal receiving device 21. At this time, it is assumed that the weather information providing apparatus 20 further calculates, from the respective water vapor values D, the water vapor value D at a point where the GPS signal receiving device 21 is not installed and also stores the water vapor value D considering the point as a measurement point. Moreover, it is assumed that the satellite image providing apparatus 30 acquires the satellite image P captured by the weather satellite 32 in the sky above the Earth and stores the type of the satellite image P, satellite location information representing the location of the weather satellite 32 and satellite identification information identifying the weather satellite 32.

After that, the water vapor observation apparatus 10 acquires the water vapor value D at each measurement point from the weather information providing apparatus 20. The water vapor observation apparatus 10 also acquires the satellite image P from the satellite image providing apparatus 30 (step S1).

Subsequently, the water vapor observation apparatus 10 performs a process to identify, on each satellite image P, the location of each measurement point where the water vapor value D has been measured (step S2). For example, the water vapor observation apparatus 10 calculates the angle between the weather satellite 32 having captured the satellite image P and the GPS signal receiving device 21, and identifies the location of each measurement point on the satellite image P using the angle, location information of the weather satellite 32, location information of the GPS signal receiving device 21, and so forth.

Subsequently, the water vapor observation apparatus 10 extracts an image feature value at each measurement point on the satellite image P from the satellite image P (step S3). Specifically, the water vapor observation apparatus 10 extracts, based on the type of the satellite image P, an image feature value representing the condition of cloud and water vapor that can be extracted from the feature of the image. For example, the water vapor observation apparatus 10 extracts the degree of color corresponding to the thickness and altitude of cloud and a water vapor content as an image feature value on the satellite image P.

Then, the water vapor observation apparatus 10 corrects the water vapor value D at each measurement point based on the image feature value at the measurement point (step S4). That is to say, the water vapor observation apparatus 10 corrects the water vapor value D measured based on the GPS signal, based on the image feature value representing the condition of cloud and water vapor. For example, in a case where it is determined from the image feature value that cloud at the measurement point is thick, the water vapor value D measured from the GPS signal may be higher than actual, so that the water vapor observation apparatus 10 corrects the value of the water vapor value D to be lower. Furthermore, in a case where there is a plurality of satellite images P of the same measurement point, the water vapor observation apparatus 10 corrects the water vapor value D at the measurement point based on image feature values at the same observation point obtained from the respective captured images P. For example, in a case where there are satellite images P of different types from each other, the water vapor observation apparatus 10 provides the image feature value for each type with a weight previously set for the type, and corrects the water vapor value D based on the image feature values provided with the weights. Moreover, in a case where there are satellite images P captured by different weather satellites 32 from each other, the water vapor observation apparatus 10 provides each image feature value with a weight previously set for the weather satellite 32, and corrects the water vapor value D based on the image feature values provided with the weights.

The water vapor observation apparatus 10 stores the water vapor value D corrected as described above into the water vapor value storing unit 16. Then, the water vapor observation apparatus 10 outputs the water vapor value D stored in the water vapor value storing unit 16 together with location information representing the measurement point as needed, for example, at the time of using for weather prediction.

Thus, according to the present invention, a water vapor value measured based on a GPS signal is corrected based on an image feature value extracted from a satellite image. Therefore, even when a value different from an actual condition is measured based on the GPS signal, the value can be corrected to an appropriate value based on a weather condition such as the thickness and altitude of cloud, a water vapor content and the like that can be extracted from the satellite image. As a result, a water vapor content can be observed at every point with more accuracy. Then, by performing weather prediction using the observed water vapor content, it is possible to accurately predict rainfall and torrential rain.

### Second Example Embodiment

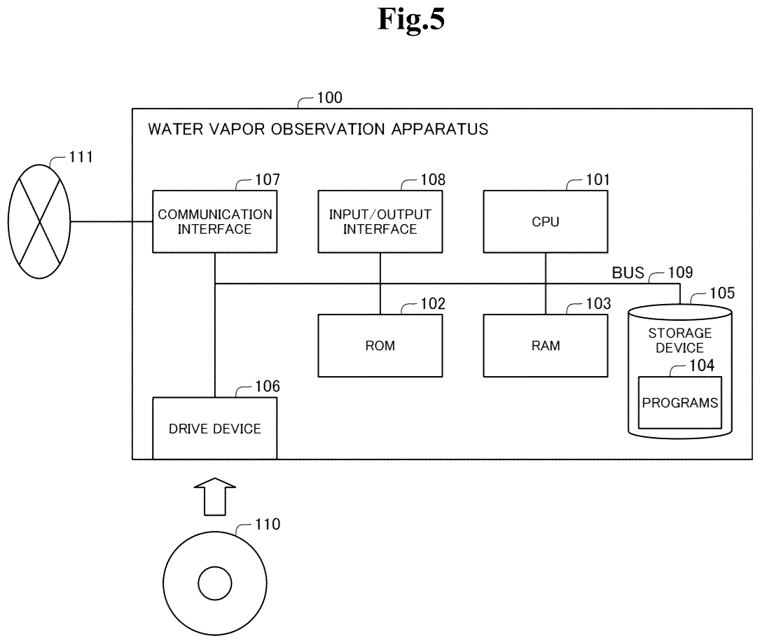

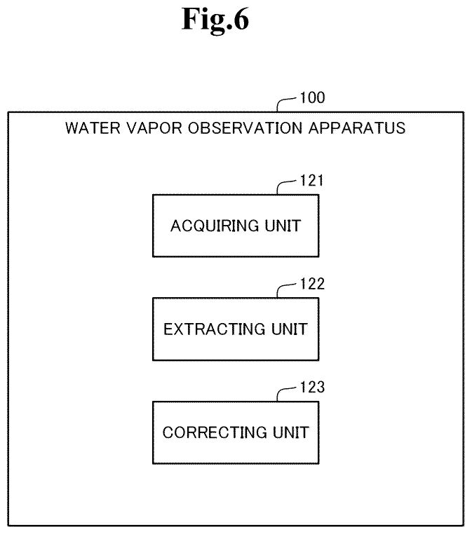

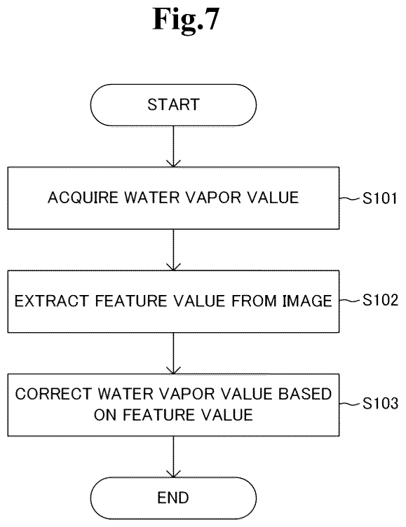

Next, a second example embodiment of the present invention will be described with reference to FIGS. 5 to 7. FIGS. 5 and 6 are block diagrams showing a configuration of a water vapor observation apparatus in the second example embodiment, and FIG. 7 is a flowchart showing operation of the water vapor observation apparatus. In this example embodiment, the overview of the configurations of the water vapor observation apparatus and the water vapor observation method described in the above example embodiment is shown.

First, with reference to FIG. 5, a hardware configuration of a water vapor observation apparatus 100 in this example embodiment will be described. The water vapor observation apparatus 100 is configured by a general information processing apparatus and, as an example, has the following hardware configuration including;
a CPU (Central Processing Unit) 101 (arithmetic logic unit),
a ROM (Read Only Memory) 102 (memory unit),
a RAM (Random Access Memory) 103 (memory unit),
programs 104 loaded to the RAM 103,
a storage device 105 storing the programs 104,
a drive device 106 reading from and writing into a storage medium 110 outside the information processing apparatus,
a communication interface 107 connected to a communication network 111 outside the information processing apparatus,
an input/output interface 108 performing input and output of data, and
a bus 109 connecting the respective components.

Then, the water vapor observation apparatus 100 can construct and include an acquiring unit 121, an extracting unit 122 and a correcting unit 123 shown in FIG. 6 by acquisition and execution of the programs 104 by the CPU 101. The programs 104 are, for example, stored in advance in the storage device 105 or the ROM 102, and loaded to the RAM 103 and executed by the CPU 101 as necessary. Moreover, the programs 104 may be delivered to the CPU 101 via the communication network 111, or may be stored in advance in the storage medium 110 and retrieved and delivered to the CPU 101 by the drive device 106. However, the acquiring unit 121, the extracting unit 122, and the correcting unit 123 described above may be constructed by an electric circuit dedicated for implementation of such means.

FIG. 5 shows an example of the hardware configuration of the information processing apparatus serving as the water vapor observation apparatus 100, and the hardware configuration of the information processing apparatus is not limited to the above case. For example, the information processing apparatus may be configured by part of the above configuration, such as without the drive device 106.

Then, the water vapor observation apparatus 100 executes a water vapor observation method shown in the flowchart of FIG. 7 by the functions of the acquiring unit 121, the extracting unit 122 and the correcting unit 123 constructed by the program as described above.

As shown in FIG. 7, the water vapor observation apparatus 100 executes processes to:
acquire a water vapor value at each predetermined point measured based on a received signal from a satellite (step S101);
extract a feature value for each predetermined point from a captured image having been captured from sky (step S102); and correct the water vapor value based on the feature value for each predetermined point (step S103).

With the configuration as described above, the present invention corrects a water vapor value based on a received signal from a satellite, based on a feature value extracted from a captured image having been captured from the sky. Consequently, it is possible to observe a water vapor content with more accuracy at every point.

The abovementioned program can be stored using various types of non-transitory computer-readable mediums and delivered to a computer. The non-transitory computer-readable mediums include various types of tangible storage mediums. Examples of the non-transitory computer-readable mediums include a magnetic recording medium (e.g., flexible disk, magnetic tape, hard disk drive), a magneto-optical recording medium (e.g., magneto-optical disk), a CD-ROM (Read Only Memory), a CD-R, a CD-RW, and a semiconductor memory (e.g., mask ROM, PROM (Programmable ROM), EPROM (Erasable PROM), flash ROM, RAM (Random Access Memory)). The program may also be delivered to a computer by various types of transitory computer-readable mediums. Examples of the transitory computer-readable mediums include electric signal, optical signal, and electromagnetic wave. The transitory computer-readable medium can deliver the program to a computer via a wired communication path such as electric line and optical fiber, or via a wireless communication path.

Although the present invention has been described above with reference to the example embodiments, the present invention is not limited to the above example embodiments. The configurations and details of the present invention can be changed in various manners that can be understood by one skilled in the art within the scope of the present invention. Moreover, at least one or more of the functions of the acquiring unit 121, the extracting unit 122 and the correcting unit 123 described above may be executed by an information processing apparatus installed and connected at any place on a network, that is, may be executed on so-called cloud computing.

### Supplementary Notes

The whole or part of the example embodiments disclosed above can be described as the following supplementary notes. Below, the overview of configurations of a water vapor observation method, a water vapor observation apparatus and a program according to the present invention will be described. However, the present invention is not limited to the following configurations.

### Supplementary Note 1

A water vapor observation method comprising:
acquiring a water vapor value at each predetermined point measured based on a received signal from a satellite;
extracting a feature value for each predetermined point from a captured image captured from sky; and
correcting the water vapor value based on the feature value for each predetermined point.

### Supplementary Note 2

The water vapor observation method according to Supplementary Note 1, comprising extracting the feature value based on a type of the captured image.

### Supplementary Note 3

The water vapor observation method according to Supplementary Note 1 or 2, comprising extracting the feature value representing a condition of cloud for each predetermined point from the captured image.

### Supplementary Note 4

The water vapor observation method according to any of Supplementary Notes 1 to 3, comprising
extracting the feature value representing a condition of water vapor for each predetermined point from the captured image.

### Supplementary Note 5

The water vapor observation method according to any of Supplementary Notes 1 to 4, comprising:
extracting the feature values from a plurality of the captured images, respectively; and
correcting the water vapor value based on the feature values extracted from the captured images, respectively.

### Supplementary Note 6

The water vapor observation method according to Supplementary Note 5, comprising:
extracting the feature values from the captured images based on types of the satellite images, respectively; and
correcting the water vapor value based on values obtained by providing the feature values extracted from the captured images, respectively, with weights previously set for the types of the satellite images, respectively.

### Supplementary Note 7

The water vapor observation method according to Supplementary Note 5 or 6, comprising
correcting the water vapor value based on values obtained by providing the feature values extracted from the captured images, respectively, with weights previously set for imaging devices having captured the captured images from the sky.

### Supplementary Note 8

The water vapor observation method according to any of Supplementary Notes 1 to 7, comprising:
acquiring the water vapor value measured based on a radio signal received from a GPS (Global Positioning System) satellite; and
extracting the feature value from the captured image captured by an imaging device mounted on a predetermined satellite.

### Supplementary Note 9

A water vapor observation apparatus comprising:
an acquiring unit that acquires a water vapor value at each predetermined point measured based on a received signal from a satellite;
an extracting unit that extracts a feature value for each predetermined point from a captured image captured from sky; and
a correcting unit that corrects the water vapor value based on the feature value for each predetermined point.

### Supplementary Note 10

The water vapor observation apparatus according to Supplementary Note 9, wherein
the extracting unit extracts the feature value based on a type of the captured image.

### Supplementary Note 11

The water vapor observation apparatus according to Supplementary Note 9 or 10, wherein the extracting unit extracts the feature value representing a condition of cloud for each predetermined point from the captured image.

### Supplementary Note 12

The water vapor observation apparatus according to any of Supplementary Notes 9 to 11, wherein
the extracting unit extracts the feature value representing a condition of water vapor for each predetermined point from the captured image.

### Supplementary Note 13

The water vapor observation apparatus according to any of claims 9 to 12, wherein:
the extracting unit extracts the feature values from a plurality of the captured images, respectively; and
the correcting unit corrects the water vapor value based on the feature values extracted from the captured images, respectively.

### Supplementary Note 14

The water vapor observation apparatus according to Supplementary Note 13, wherein:
the extracting unit extracts the feature values from the captured images based on types of the satellite images, respectively; and
the correcting unit corrects the water vapor value based on values obtained by providing the feature values extracted from the captured images, respectively, with weights previously set for the types of the satellite images, respectively.

### Supplementary Note 15

The water vapor observation apparatus according to Supplementary Note 13 or 14, wherein
the correcting unit corrects the water vapor value based on values obtained by providing the feature values extracted from the captured images, respectively, with weights previously set for imaging devices having captured the captured images from the sky.

### Supplementary Note 16

The water vapor observation apparatus according to any of Supplementary Notes 9 to 15, wherein:
the acquiring unit acquires the water vapor value measured based on a radio signal received from a GPS (Global Positioning System) satellite; and
the extracting unit extracts the feature value from the captured image captured by an imaging device mounted on a predetermined satellite.

### Supplementary Note 17

A non-transitory computer-readable storage medium storing a program comprising instructions for causing an information processing apparatus to execute processes to:
acquire a water vapor value at each predetermined point measured based on a received signal from a satellite;
extract a feature value for each predetermined point from a captured image captured from sky; and
correct the water vapor value based on the feature value for each predetermined point.

The present invention is based upon and claims the benefit of priority from Japanese patent application No. 2021-041771, filed on Mar. 15, 2021, the disclosure of which is incorporated herein in its entirety by reference.

### REFERENCE SIGNS LIST

10 water vapor observation apparatus
11 acquiring unit
12 extracting unit
13 correcting unit
16 water vapor value storing unit
17 satellite image storing unit
20 weather information providing apparatus
21 GPS signal receiving device
22 GPS satellite
30 satellite image providing apparatus
31 satellite image receiving device
32 weather satellite
100 water vapor observation apparatus
101 CPU
102 ROM
103 RAM
104 programs
105 storage device
106 drive device
107 communication interface
108 input/output interface
109 bus
110 storage medium
111 communication network
121 acquiring unit
122 extracting unit
123 correcting unit

What is claimed is:

1. A water vapor observation method comprising:
acquiring a water vapor value at each predetermined point measured based on a received signal from a satellite;
extracting a feature value for each predetermined point from a captured image captured from sky; and
correcting the water vapor value based on the feature value for each predetermined point.

2. The water vapor observation method according to claim 1, comprising extracting the feature value based on a type of the captured image.

3. The water vapor observation method according to claim 1, comprising
extracting the feature value representing a condition of cloud for each predetermined point from the captured image.

4. The water vapor observation method according to claim 1, comprising
extracting the feature value representing a condition of water vapor for each predetermined point from the captured image.

5. The water vapor observation method according to claim 1, comprising:
extracting the feature values from a plurality of the captured images, respectively; and
correcting the water vapor value based on the feature values extracted from the captured images, respectively.

6. The water vapor observation method according to claim 5, comprising:
extracting the feature values from the captured images based on types of the satellite images, respectively; and
correcting the water vapor value based on values obtained by providing the feature values extracted from the captured images, respectively, with weights previously set for the types of the satellite images, respectively.

7. The water vapor observation method according to claim 5, comprising
correcting the water vapor value based on values obtained by providing the feature values extracted from the captured images, respectively, with weights previously set for imaging devices having captured the captured images from the sky.

8. The water vapor observation method according to claim 1, comprising:
acquiring the water vapor value measured based on a radio signal received from a GPS (Global Positioning System) satellite; and
extracting the feature value from the captured image captured by an imaging device mounted on a predetermined satellite.

9. A water vapor observation apparatus comprising:
at least one memory configured to store instructions; and
at least one processor configured to execute the instructions to:
acquire a water vapor value at each predetermined point measured based on a received signal from a satellite;
extract a feature value for each predetermined point from a captured image captured from sky; and
correct the water vapor value based on the feature value for each predetermined point.

10. The water vapor observation apparatus according to claim 9, wherein the at least one processor is configured to execute the instructions to
extract the feature value based on a type of the captured image.

11. The water vapor observation apparatus according to claim 9, wherein the at least one processor is configured to execute the instructions to
extract the feature value representing a condition of cloud for each predetermined point from the captured image.

12. The water vapor observation apparatus according to claim 9, wherein the at least one processor is configured to execute the instructions to
extract the feature value representing a condition of water vapor for each predetermined point from the captured image.

13. The water vapor observation apparatus according to claim 9, wherein the at least one processor is configured to execute the instructions to:
extract the feature values from a plurality of the captured images, respectively; and
correct the water vapor value based on the feature values extracted from the captured images, respectively.

14. The water vapor observation apparatus according to claim 13, wherein the at least one processor is configured to execute the instructions to:
extract the feature values from the captured images based on types of the satellite images, respectively; and
correct the water vapor value based on values obtained by providing the feature values extracted from the captured images, respectively, with weights previously set for the types of the satellite images, respectively.

15. The water vapor observation apparatus according to claim 13, wherein the at least one processor is configured to execute the instructions to
correct the water vapor value based on values obtained by providing the feature values extracted from the captured images, respectively, with weights previously set for imaging devices having captured the captured images from the sky.

16. The water vapor observation apparatus according to claim 9, wherein the at least one processor is configured to execute the instructions to:
acquire the water vapor value measured based on a radio signal received from a GPS (Global Positioning System) satellite; and
extract the feature value from the captured image captured by an imaging device mounted on a predetermined satellite.

17. A non-transitory computer-readable storage medium storing a program comprising instructions for causing an information processing apparatus to execute processes to:
acquire a water vapor value at each predetermined point measured based on a received signal from a satellite;
extract a feature value for each predetermined point from a captured image captured from sky; and
correct the water vapor value based on the feature value for each predetermined point.
